(19) United States
(12) Patent Application Publication
(10) Pub. No.: US 2024/0147983 A1
(43) Pub. Date: May 9, 2024

(54) METHOD AND APPARATUS FOR CONTROLLING PEST ANIMALS

(71) Applicant: Catch Data IP Holdings Ltd., Kelowna (CA)

(72) Inventors: Mark Krehel, Kelowna (CA); Ken Gauthier, Kelowna (CA); Lucas Ferguson, Kelowna (CA)

(21) Appl. No.: 18/501,220

(22) Filed: Nov. 3, 2023

Related U.S. Application Data
(60) Provisional application No. 63/422,910, filed on Nov. 4, 2022.

(51) Int. Cl. A01M 23/30

(52) U.S. Cl. CPC A01M 23/30

(57) ABSTRACT

A method and apparatus for controlling animal pests wherein the apparatus comprises a housing having a passage extending into the housing from an entrance, an impacting member movable across the passage, at least one scanner positioned to scan the animal pest a processor. The processor is operably coupled to the at least one scanner and the impacting member and is configured to receive information from the scanner and adjust at least one operating parameter of the impacting member wherein the impacting member is operable to be released to rapidly move across the passage. The method comprises scanning with the scanner the animal pest and adjusting with the processor, at least one operating parameter of the impacting member.

### CROSS-REFERENCE TO RELATED APPLICATIONS

This application claims the benefit of U.S. Provisional Application No. 63/422,910 filed Nov. 4, 2022, which is incorporated herein by reference in its entirety.

### FIELD OF THE DISCLOSURE

This disclosure relates generally to controlling pest animal populations and in particular to a method and apparatus for terminating and containing rodents without the use of poisonous substances.

### BACKGROUND

Rodents such as rats and mice along with other animals are a frequent pest animal in many locations. Conventional attempts to control pests have been commonly divided into either trapping or poisoning them. Such conventional approaches have not been satisfactory. In particular, it has been found that use of poisons risks poisoning or killing other species which may also consume the poisoned bait or the bodies of the dead animals after they are killed by the poison.

Furthermore, conventional traps have also been unsatisfactory. In particular, common styles of rodent traps utilize a spring loaded arm released by a catch which is intended to catch and usually kill the animal. One disadvantage of such traps is that they may only be used a single time before being required to be checked and reset by a user.

Applicant is aware of attempts to correct the aforementioned defects by providing an automatic rodent trap utilizing a trigger rod positioned in a chamber into which a rodent is drawn by a bait. The trigger rod, when rotated by the rodent releases a valve thereby releasing a spring loaded kill mechanism operable to impact and kill the rodent in the chamber. An example of such device may be found in US Patent Application Publication No. 2017/0202206 to Bond et al. Disadvantageously, such devices rely upon movement of the trigger rod and are unable to permit the movement of the kill mechanism to suit any characteristic of the animal, including size or species. Such devices may therefore be less humane in killing animal pests by contacting a less than optimal location on the body of the animal or kill animals that are not deemed pests.

This background information is provided to reveal information believed by the applicant to be of possible relevance. No admission is necessarily intended, nor should be construed, that any of the preceding information constitutes prior art or forms part of the general common knowledge in the relevant art.

### SUMMARY OF THE DISCLOSURE

According to a first embodiment, there is disclosed an apparatus for controlling animal pests comprising a housing having a passage extending into the housing from an entrance, an impacting member movable across the passage, a scanner positioned to scan the animal pest and a processor. The processor is operably coupled to the at least one sensor and the impacting member and is configured to receive information from the scanner and adjust at least one operating parameter of the impacting member wherein the impacting member is operable to be released to rapidly move across the passage.

The scanner may measure at least one characteristic of the animal pest within the passage. The at least one characteristic may comprise the identification of the species of animal pest. The at least one characteristic may comprise the size of the animal pest.

The scanner may comprise a camera. The information provided from the scanner to the processor may comprise an image of the animal pest. The processor may be configured to identify the animal pest from the image. The processor may be configured to locate a desired body part to be impacted on the animal pest.

The at least one operating parameter of the impactor may comprise adjusting the trigger timing of when the impactor is caused to move across the passage. The trigger timing may be adjusted in relation to a time when the pest animal is detected by the scanner. The at least one operating parameter of the impactor may comprise whether the impactor is permitted to move depending on the identification of the animal pest.

The apparatus may further comprise at least one sensor located within passage operably coupled to the processor, the sensor positioned to provide a location of the animal pest within the passage. The at least one sensor may be selected from the group consisting of an infrared sensor, a laser sensor, a light beam sensor and a mechanical switch. The at least one operating parameter may vary which sensor is utilized by the processor to trigger movement of the impacting member.

According to a first embodiment, there is disclosed a method for controlling animal pests comprising providing a housing having a passage extending thereinto from an entrance, locating an impacting member movable across the passage, scanning with a scanner an animal pest entering the passage, receiving, at a processor, operably coupled to the at least one sensor and the impacting member, an output from the scanner and adjusting with the processor, at least one operating parameter of the impacting member.

In accordance with another aspect, there is provided an apparatus for controlling animal pests comprising: a housing having a passage extending into the housing from an entrance; an impacting member movable across the passage; and at least one scanner positioned to scan the animal pest; a processor, operably coupled to the at least one scanner and the impacting member, the processor configured to receive scanning information from the at least one scanner and adjust at least one operating parameter of the impacting member based on the scanning information, wherein the impacting member is operable to be released to rapidly move across the passage.

In some embodiments, the processor is further configured to identify at least one characteristic of the animal pest within the passage based on said scanning information, and wherein said adjusting is based on the at least one characteristic.

In some embodiments, the at least one characteristic comprises an identification of the species of the animal pest.

In some embodiments, the at least one characteristic is selected from the group consisting of: size, age, gender, body profile and weight of the animal pest.

In some embodiments, the scanner is selected from the group consisting of: an optical camera, an infrared camera, an array of depth sensors, a LiDAR or lasers.

In some embodiments, the scanning information provided from the at least one scanner to the processor comprises a representation of the animal pest.

In some embodiments, the processor is configured to locate based on said profile or representation an anatomical point of the pest animal to be impacted.

In some embodiments, the adjusting at least one operating parameter of the impacting member comprises adjusting the trigger timing of when the impacting member is caused to move across the passage.

In some embodiments, adjusting at least one operating parameter of the impacting member comprises determining whether the impacting member is permitted to move or not depending on the identification of the animal pest.

In some embodiments, the apparatus further comprises at least one sensor operably coupled to the processor and located within the passage, the at least one sensor configured to provide a location of the animal pest within the passage.

In some embodiments, the at least one sensor is selected from the group consisting of an infrared sensor, a laser sensor, a light beam sensor, a motion sensor, a proximity sensor, a time-of-flight sensor, an ultrasonic sensor, a microwave sensor, a laser, an optical sensor, and a mechanical switch.

In some embodiments, the at least one sensor is an array of sensors, each sensor in the array of sensors located at a different sensor location within the passage; and wherein adjusting at least one operating parameter includes selecting which sensor in the array of sensors is utilized by the processor to trigger movement of the impacting member.

In accordance with another aspect, there is provided a method for controlling animal pests comprising: providing a housing having a passage extending thereinto from an entrance; locating an impacting member movable across the passage; scanning with at least one scanner an animal pest entering the passage; receiving, at a processor operably coupled to the at least one scanner and the impacting member, scanning information from the at least one scanner; and adjusting, with the processor, at least one operating parameter of the impacting member based on the scanning information.

In some embodiments, the method further comprises: triggering, by the processor, the release of the impacting member based on said at least one operating parameter.

In some embodiments, the method further comprises the step of, before said adjusting but after said receiving: identifying at least one characteristic of the animal pest within the passage based on said scanning information; and wherein said adjusting is based on the at least one characteristic.

In some embodiments, the at least one characteristic comprises an identification of the species of animal pest.

In some embodiments, adjusting at least one operating parameter of the impacting member comprises adjusting the trigger timing of when the impacting member is caused to move across the passage.

In some embodiments, adjusting at least one operating parameter of the impacting member comprises determining whether the impacting member is permitted to move or not depending on the identification of the animal pest.

In some embodiments, adjusting at least one operating includes selecting which sensor in an array of sensors located within the passage is utilized by the processor to trigger movement of the impacting member.

In accordance with another aspect, there is provided a non-transitory computer-readable medium storing instructions that, when executed by a processor, causes the processor to: receive scanning information from at least one scanner operably coupled to the processor and configured to scan an animal pest entering a passage extending into a housing from an entrance; and adjust at least one operating parameter of an impacting member coupled to the processor based on said scanning information.

Other aspects and features of the present disclosure will become apparent to those ordinarily skilled in the art upon review of the following description of specific embodiments in conjunction with the accompanying figures.

### BRIEF DESCRIPTION OF THE DRAWINGS

The accompanying drawings constitute part of the disclosure. Each drawing illustrates exemplary aspects wherein similar characters of reference denote corresponding parts in each view.

FIG. 1 is a perspective view of an apparatus for controlling pest animals according to a first embodiment of the present disclosure.

FIG. 2 is a perspective view of the apparatus of FIG. 1 with the top cover removed.

FIG. 3 is a cross sectional view of the apparatus of FIG. 1 as taken along the line 3-3 with the impactor at a first or ready position.

FIG. 4 is a cross sectional view of the apparatus of FIG. 1 as taken along the line 3-3 with the impactor at a second or striking position.

FIG. 5 is a block diagram of the control system of the apparatus of FIG. 1.

FIG. 6 is an illustration of an image of an animal pest as taken by the scanner for use in the apparatus of FIG. 1.

FIG. 7 is an illustration of a chart illustrating modification of the timing of the impacting member timing of the apparatus of FIG. 1.

FIG. 8 is a cross sectional view of a passage having a plurality of sensors according to a further embodiment.

FIG. 9 is a top plan view of a rotating arm according to a further embodiment of the present disclosure.

FIG. 10 is a perspective view of a passage having a plurality of scanners according to a further embodiment of the present disclosure.

FIG. 11 is a representation of a scanned image compared against a target image in the embodiment of FIG. 10.

FIG. 12A and FIG. 12B are cross sectional views of a passage having a plurality of sensors and scanner(s), in accordance with two embodiments.

FIG. 13 is a perspective view of a light source and receiver, in accordance with one embodiment.

Elements in the several drawings are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

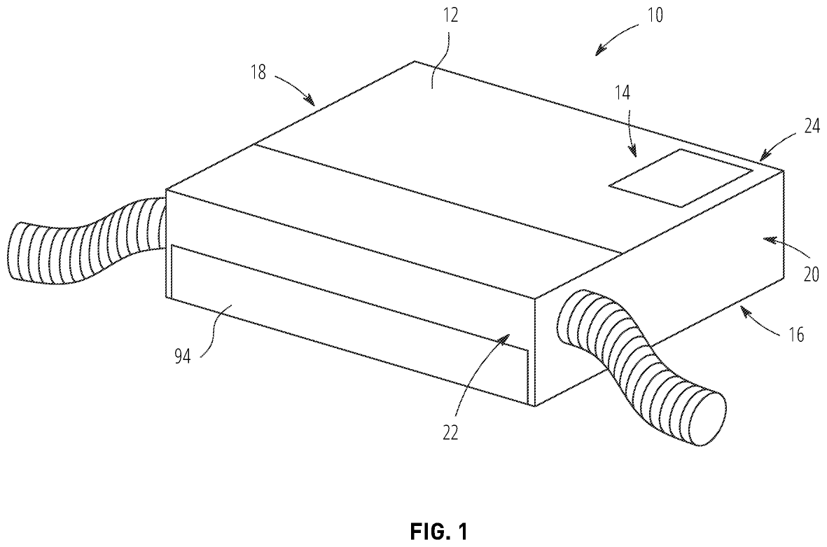

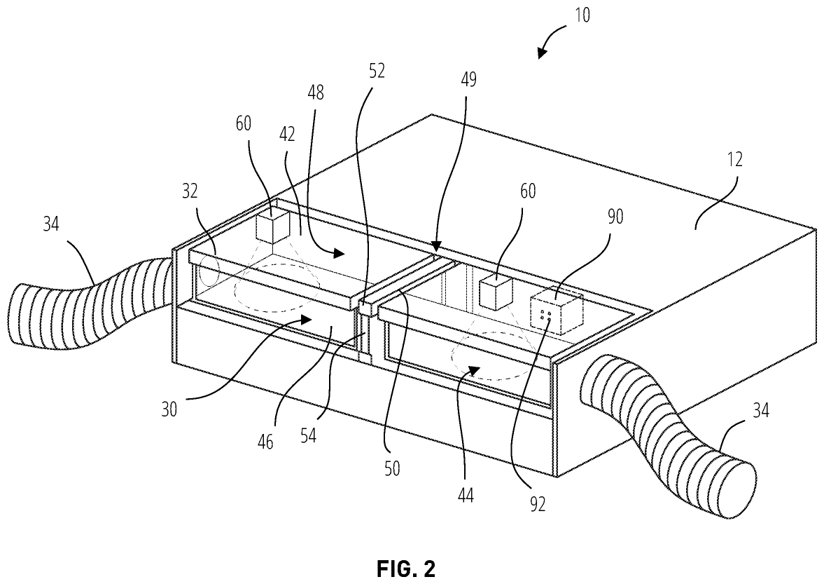

Aspects of the present disclosure are now described with reference to exemplary apparatuses, methods and systems. Referring to FIG. 1 and FIG. 2, an exemplary apparatus for controlling an animal pest according to a first embodiment is shown generally at 10. The apparatus 10 comprises a casing 12 having a path therethrough as will be more fully described below. The passage 30 includes an impacting member 54 positioned to move across the path towards so as to kill the rodent before dropping it into a catchment container 94 in the bottom of the apparatus 10.

As utilized herein, the term animal pest will be understood to mean any animal population which is desirous of being controlled. In particular, the term animal is not meant to be limiting but may be utilized to describe any animal, including without limitation, birds, rabbits, snakes, rodents, such as by way of non-limiting example, rats, mice, squirrels, marmots or any other animal species considered to be a pest.

The casing 12 may be formed of any suitable shape and extend between top and bottom, 14 and 16, respectively, first and second sides, 18 and 20, respectively and front and rear, 22 and 24, respectively. The casing 12 may be made of any suitable material including by way of non-limiting example, plastics, metal or composite materials. The casing 12 includes a passage, generally indicated at 30 in FIG. 2, comprising a passage 30 extending between the first and second sides 18 and 20 proximate to the front 22. The path is substantially closed off from the remainder of the casing 12 so as to prevent a rodent which enters the passage 30 from entering the remaining areas of the casing 12. Each of the first and second sides 18 and 20 includes an aperture or entrances 32 therethrough so as to permit access of a rodent into the passage 30. As illustrated in FIG. 1 and FIG. 2, the apparatus 10 may further include ramps or tubes 34, so as to assist entrance of a rodent into the passage 30. The tubes 34 may be substantially flexible so as to permit the open end thereof to be located at any desired location around the apparatus 10, thereby increasing flexibility in the location of the apparatus relative to the inlet location. Although the present description contemplates the apparatus 10 being used to catch rats, it will be appreciated that it may also be utilized to catch other types of rodents, including, without limitation, mice, squirrels, as well as other pests including birds such as pigeons and the like.

As illustrated in FIG. 2, the passage 30 is formed through the top front of the casing 12 by top and bottom walls, 42 and 44, respectively and front and rear walls, 46 and 48, respectively. As illustrated in FIG. 2, the top and front 42 and 46 are transparent for illustrative purposes although they may be of any opacity level. In particular, it has been found that transparent top and front walls 42 and 46 may be advantageous for reducing stress of the target animal. The passage 30 may be formed of formed of any suitable material including plastic panels, wire mesh, wooden bars or any other solid or semi-open barriers adapted to guide the animal to the impacting member 54. Furthermore, one or more of the top or front walls 42 and 46 may be formed with openings therethrough so as the top and front walls 42 and 46 may also form the top and front 14 and 22 top of the casing 12 or may be separate from those portions forming the casing 12. The top and bottom walls 42 and 44 and front and rear walls 46 and 48 form the passage 30 through the casing 12. The passage 30 selected to have dimensions suitable for the desired rodent to pass through. By way of non-limiting example, for use as a rat trap, the passage 30 may have a width between 2 and 4 inches (51 and 102 mm) and a height between 2 and 4 inches (51 and 102 mm) for use with catching rats although it will be appreciated that other dimensions may be useful as well for use with catching different animals. The passage 30 may have a constant cross section as illustrated or may taper closer to the impacting member 54. The bottom wall 44 forms a walking surface on which the rodent walks and will therefore be formed to have sufficient strength to support the weight of the rodent. The bottom wall 44 may also be formed to have a surface that is relatively smooth to permit a dead rodent to be slid off into a catchment container 94.

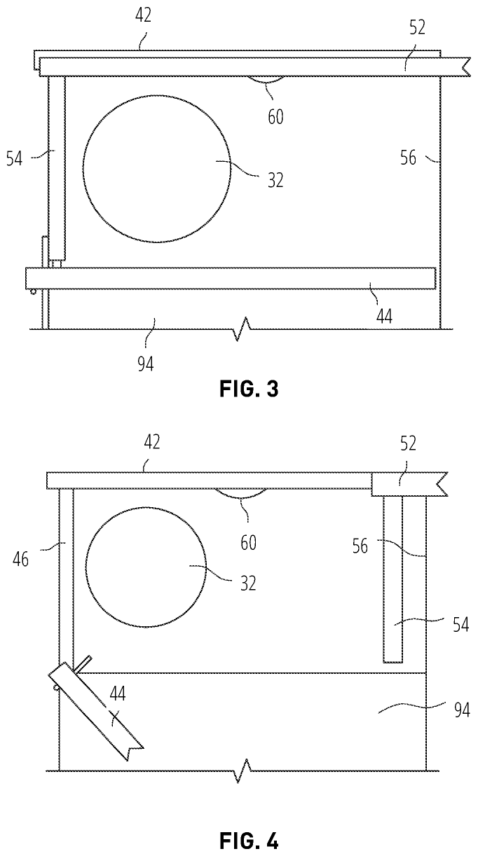

As illustrated, in FIG. 2, the top and front and rear 42, 46 and 48 are divided into portions extending from each of the first and second sides 18 and 20 of the casing 12 with a gap, generally indicated at 49 therebetween. A slidable arm 50 extends to a free distal end 52 through the gap 49 from the rear wall 48 towards the front wall 46 along a path substantially planar to the top wall 42. An impactor 54 extends downwardly from the slidable arm 50 such that as the slidable arm 50 is slidably displaced along its longitudinal path, the impactor 54 moves from a position substantially planar to the front wall 46 as illustrated in FIG. 3 to a position proximate to the rear wall 48 as illustrated in FIG. 4. It will be appreciated that at the retracted position illustrated in FIG. 4, the impactor 54 will pinch or otherwise impact the neck of a rodent against the rear wall 48, thereby breaking it and humanely killing the rodent. The rear wall 48 may optionally include a strengthened or reinforced portion or anvil 56 adapted to resist movement as the rodent is forced thereinto by the movement of the impactor 54.

The apparatus 10 may include at least one scanner 60 located along the passage 30 as illustrated in FIG. 2. As illustrated in FIG. 2, the scanner 60 may be located in the tubes 34 above the passage 30 although it will be appreciated that the scanner 60 may also be located at any other position along the passage 30 including either side wall 46 or 48 or in the bottom wall 44. The scanner 60 may also optionally be located at or near an entrance 32 to the passage 30 so as to be operable to scan the animal pest as it enters the passage 30 as opposed to while it is inside the passage 30. According to some embodiments, the scanner 60 may comprise a camera although other scanners 60 may also be utilized that are capable of scanning the animal pest and producing an image or other representation thereof. Examples of such scanners 60 may include visual sensors, optical or infrared cameras, an array of depth, time-of-flight or ultrasonic sensors, LiDAR or lasers. As will be further described below, the scanner 60 is configured to transmit the captured image to the processor 102 for identification of one or more features of the animal pest wherein the processor 102 is also configured to adapt or adjust one or more operating parameters of the impactor 54 to provide a more humane kill or a selective kill of the animal pest located within the passage 30.

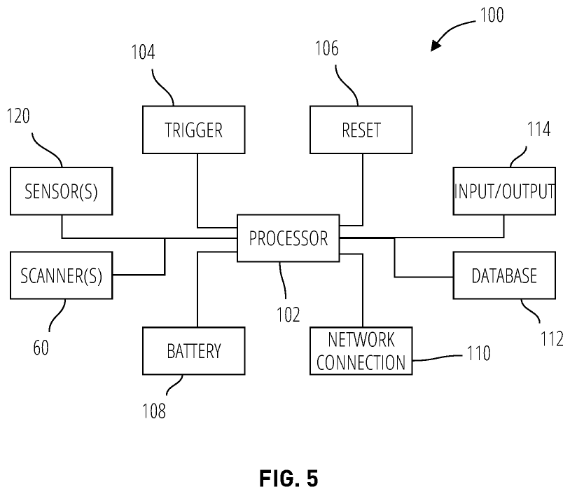

Turning now to FIG. 5, a controller system 100 for operating the apparatus 10 is illustrated. The control system 100 includes a processor 102 adapted to control the operation of the various components and store and transmit information as may be recorded by the apparatus 10 as set out below. More generally, in this specification, including the claims, the term “processor” is intended to broadly encompass any type of device or combination of devices capable of performing the functions described herein, including (without limitation) other types of microprocessors, microcontrollers, other integrated circuits, other types of circuits or combinations of circuits, logic gates or gate arrays, or programmable devices of any sort, for example, either alone or in combination with other such devices located at the same location or remotely from each other, for example. Additional types of processors will be apparent to those ordinarily skilled in the art upon review of this specification, and substitution of any such other types of processor circuits is considered not to depart from the scope of the present disclosure.

The processor 102 is in communication with the one or more scanners 60 and a trigger 104 configured to release the impactor 54 for an impacting movement across the passage 30. The processor 102 may also be operably connected to a reset mechanism 106 for resetting the position of the impactor 54 to an initial or pre-strike position. Mechanisms for such killing and reset movement of the impactor 54 are known in the art and are not illustrated or described herein for brevity. The control system 100 may also include a battery 108 providing power to the various components and a network connection 110 such as a radio transmitter, Ethernet adapter or the like for providing communication for providing communication between the processor 102 and one or more remote computers or users. The control system 100 may include one or more sensors 120 adapted to sense and transmit to the processor 102 the presence of an animal at a desired location within the passage 30. Optionally, the processor 102 may include a database 112 containing information on a plurality of animal pests for comparison by the processor 102 and an input/output interface 114, such as, by way of non-limiting example, a keyboard, touchscreen or monitor.

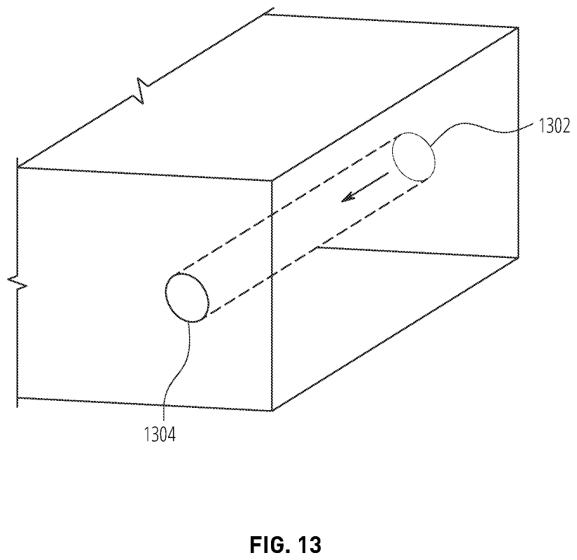

The sensors 120 may be selected to be of any suitable type to indicate the presence of a rodent or other animal proximate thereto. In particular, the sensors may comprise infrared sensors so as to detect the body heat of the rodent. Optionally, as illustrated in FIG. 13, the sensor 120 may comprise a transmitter such as a light source 1302 on one side of the passage 30 with a receiver, such as a light sensor 1304 on an opposite side wherein the presence of an animal between the light source and the receiver is operable to trigger operation of the impacting member 54. Although infrared sensors are described above, it will be appreciated that the sensor 120 may also selected to be any other type including, motion, proximity, time-of-flight, ultrasonic, microwave, thermal PIR, laser or optical sensors or a mechanical switch. Although the sensor 120 is illustrated in the tubes 34, it will be appreciated that it may also be located in other positions including the rear wall 48, bottom wall 44 or front wall 46.

By way of non-limiting examples, here are some exemplary sensor hardware that may be considered:
Microwave/Radar—Doppler Radar may be based on the BGT24LTR11 Silicon Germanium MMIC which is a 24 GHz radar transceiver. It is driven by an XMC1302 MCU based on Arm® Cortex®-MO;
Proximity Sensor—Light & Color & proximity sensor may be a TMG39931 based product, which features advanced detection, Proximity detection, Digital Ambient Light Sense (ALS), Color Sense (RGBC);
Grove Ultrasonic Sensor (US5)—Features a compact design, utilizing Time-of-Flight (ToF) principle for accurate distance measurement, and the ability to differentiate between different materials. It can measure from 3 cm to 350 cm with an accuracy of up to 2 mm. It offers plug and play connector and the easy to use tutorial;
LiDAR sensor—Short-Range ToF LIDAR Range Finder (VL53L0X) is a distance sensor of LIDAR which can emit near-infrared ray and measure the phase difference between the emitting ray and reflected ray to calculate the distance through ToF; and
Thermal Image Camera—This IR thermal camera carries a 16×12 array of thermal sensors (MLX90641) and it can detect the temperature of objects from far away with a center area accuracy of ±1° C. and average accuracy of ±1.5° C.

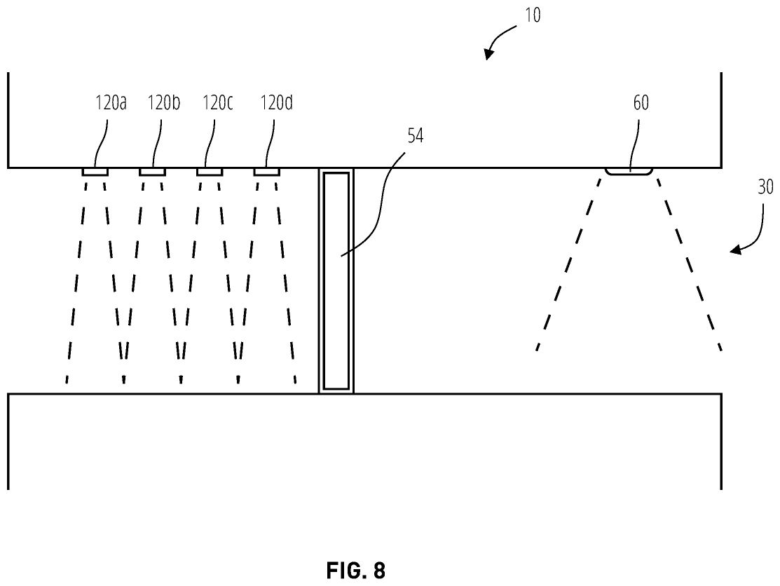

Optionally, the light source and receiver may be on the same side of the passage 30 so as to detect a reflection of light off of the target animal. As illustrated in FIG. 8, the passage 30 may include a plurality of sensors 120 located at a plurality of locations along the passage 30 (as indicated at 120a, 120b, 120c and 120d). Each of the sensor locations 120a-120d may correspond to a distance from the impactor 54 corresponding to a size of the animal pest. Furthermore, as illustrated, the sensors 120a-120d may be located on an opposite side of the impactor 54 from the scanner 60 such that the scanner 60 identifies the animal entering the passage 30 and the sensors 120a-120d are utilized to measure the distance of a portion of the animal pest to the impactor 54 as selected by the processor 102.

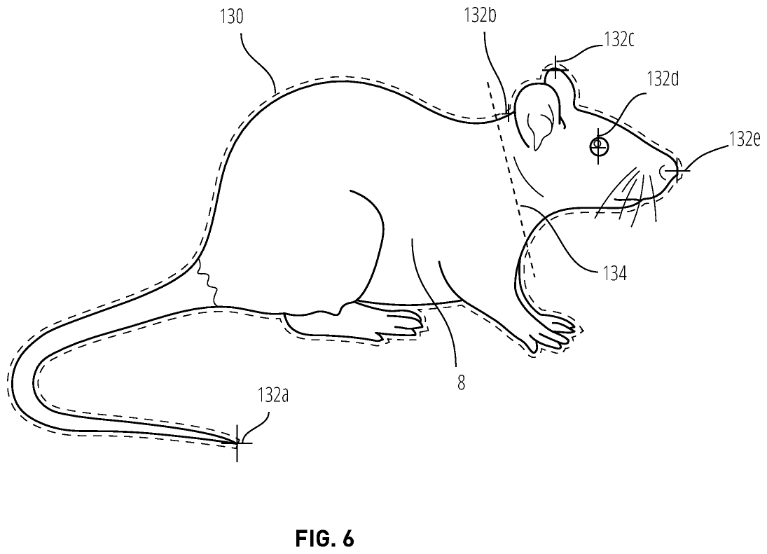

In operation, the processor 102 is configured to receive an image or other representation of the pest animal 8 located within or entering the passage 30. The processor 102 will then perform one or more operations to identify a characteristic of the animal pest 8. In particular, as illustrated in FIG. 6, a representation of the animal pest 8 as captured by the at least one scanner 60 is illustrated. As illustrated, the processor 102 may be configured to determine an outline 130 of the animal pest 8 and one or more anatomical points 132a, 132b, 132c, 132d and 132e of the animal pest. It will be appreciated that the particular points may be selected to be different in location or quantity than those shown in FIG. 6. The processor 102 utilizes the location of the anatomical points 132 and the outline 130 to identify one or more characteristics of the animal pest 8 according to known visual optical recognition methods, which will not be further set out here. In particular, the processor 102 may determine one or more of the species, size, age, weight or other characteristics of the animal pest from the scanned image. The processor 102 makes such determination based on the information stored within the database 112. The processor 102 may include instructions for executing such visual object identification located within the processor 102, database 112 or any other computer readable medium. Alternatively, the processor 102 may include such instructions as an machine learning or artificial intelligence algorithm adapted to be transformed by successive scans and operations through known methods to improve animal pest identification. Various embodiments may incorporate object detection algorithms including, without limitation YOLOv8, CenterNet, NanoDet, DeepLab V3, Inception-ResNet V2 or MobileNet V2. By way of a non-limiting example, the artificial intelligence system described herein may also incorporate exemplary hardware components such as Coral Dev Micro Board or Arduino Nicla Vision, while software elements may include TensorFlow Lite or CMSIS-NN.

The processor 102 may thereafter adjust the timing of or enable/disable the operation of the impactor 54. By way of non-limiting example, if the processor 102 determines that the animal within the passage 30 is not a species that is desired to be killed, the processor 102 may prevent the impactor 54 from being released to impact the animal. In other embodiments as illustrated in FIG. 8, the processor 102 may identify the species and/or size of the animal pest and thereafter determine a distance utilizing a permanent or machine learning algorithm stored therein to determine a distance from a nose indicated at 132e in FIG. 6 to a desired impact point 134 on the animal pest to achieve an instantaneous and humane kill. The processor 102 may thereafter select the sensor 120a-120d corresponding to the desired distance and activate the impact impacting member 54 when that selected sensor 120a-120d indicates the presence of the animal pest.

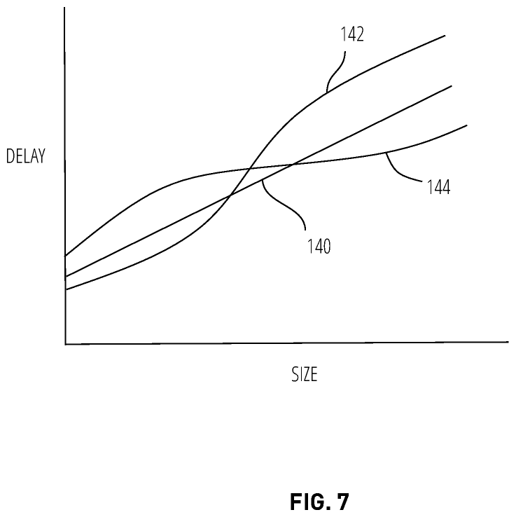

Furthermore, as illustrated in FIG. 7, the processor 102 may vary the timing of movement of the impacting member 54 (e.g., adjust the trigger timing) according to one or more maps or graphs (indicated as 140, 142 and 144 in FIG. 7) depending on the measured size or species of the animal. It will be appreciated that in such embodiments, the scanner 60 may be located proximate to the impacting member 54 wherein delay timing may be based upon the expected movement speed of the animal pest away from or towards alignment of the desired impact location 134 with the impacting member 54.

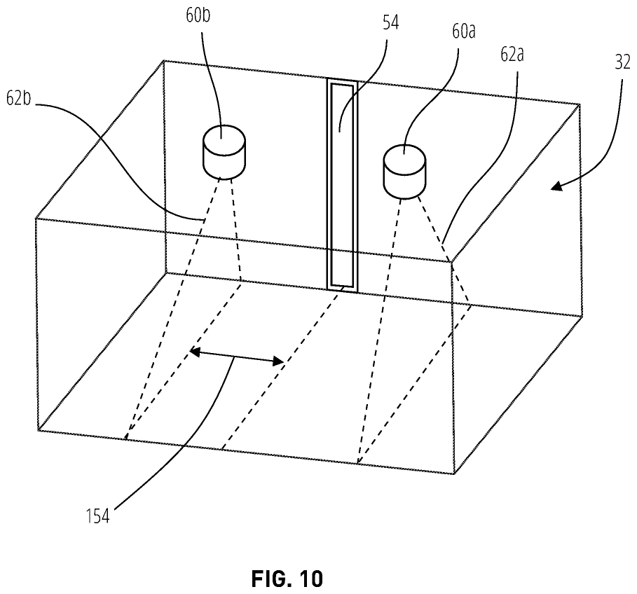

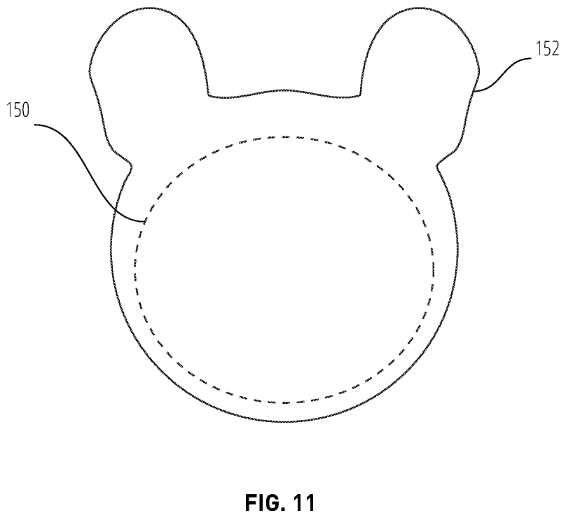

As illustrated in FIG. 10, according to a further embodiment, the passage 30 may include first and second scanners 60 to each side of the impactor 54. The scanners 60 may be selected to be capable of recording a profile or outline of the animal as it passes a first scanner 60a when moving in a direction towards the impactor 54. The processor 102 may then perform the above analysis of the animal to select the desired impact point 134 on the animal according to the identification of the animal and one or more characteristics of the animal including, such as by way of non-limiting example, size, color, texture, body profile, weight, temperature, age or gender. In particular, the first scanner 60a may in particular be operable to scan and determine a plurality or a continuous cross-section of the animal as it passes through a first scan field 62a of the first scanner 60a. The first scanner 60a may be configured to capture either a static image at a point in time, multiple images, or a live dynamic image for processing and analysis by the processor 102. In such embodiments, the processor 102 may select the trigger cross-section 150 on the animal that is at or closest to predetermined distance 154 from the location on the animal determined to be the optimal humane killing location for that animal. Thereafter, the processor 102 may monitor the scan field 62b of the second scanner 60b for when the trigger cross section 150 is detected at the second scanner 60b. As illustrated in FIG. 11, the processor 102 may compare the actual cross section 152 of the animal in comparison to the trigger cross section 150 for determining the optimal time to activate the impactor 54. It will be appreciated that for such embodiments, a LiDAR scanner capable or scanning a cross section profile of the animal may be useful. It will also be appreciated that one or more scanners 60 may be utilized at each location and may be arranged in an array. Optionally, the second scanner 60b may comprise a sensor 120 as set out herein adapted to detect the presence of the animal at a predetermined distance or location from the impacting member 54. In other embodiments, the first scanner 60a may be activated or enabled by the processor 102 which in turn is activated by a sensor 120 or other scanner 60 within the passage 30 or at or near the entrance 32 thereto.

As set out above, it will be appreciated that the scanners 60 and sensors 120 of the present disclosure may be combined with each other across all embodiments. By way of non-limiting example, in various embodiments, a scanner on one side of the impacting member 54 may be utilized with one or more sensors 120 on the other or vice versa. It will furthermore be appreciated that throughout the present disclosure, various means of identifying one or more characteristic, such as by way of non-limiting example, size, species etc. of the animal are recorded, scanned or captured by one or more scanner 60 or sensor 120 for adjusting the operation of the impacting member 54, including without limitation timing, or operability or inoperability. Such adjustment may in particular be utilized to adjust the operation of the impacting member 54 either alone or in combination with other sensors 120 or scanners 60 to guide the impacting member 54 to the target point on the animal for a humane and effective strike.

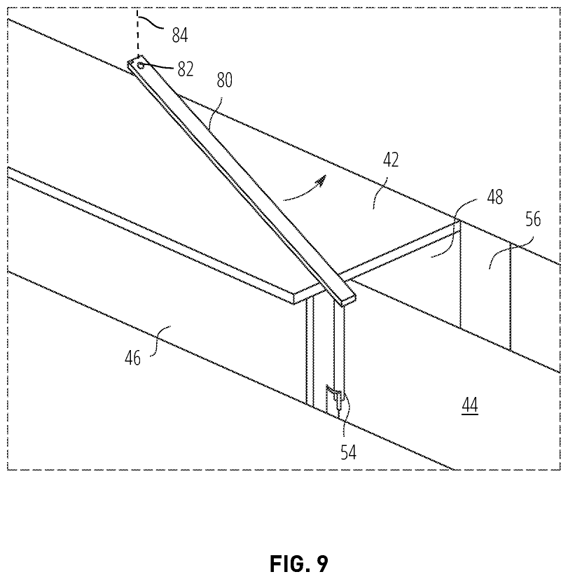

Although a slidable arm 50 is described above, it will be appreciated that other movement types for the impactor 54 may be utilized. As illustrated in FIG. 9, a rotary arm 80 may be utilized having a pivot point 82 about an axis 84. The rotary arm 80 may be rotated or activated by any common means including springs, solenoids or other actuators. As illustrated in FIG. 2, the apparatus 10 may include a bait 90 located at any position within the apparatus 10 so as to entice the rodents into the passage 30. In particular openings 92 from the bait 90 into the passage 30 may be provided to attract the rodents into the path. Examples of suitable bait 90 materials are well known in the art. The bait 90 may optionally be a solid bait type dispensed by an auger into the passage 30 or may also be a liquid or gel type bait 90 dispensed by a pump such as, by way of non-limiting example, a peristaltic pump. The apparatus 10 may further include more than one bait 90 module which may be selectively covered or uncovered by the processor 102 to vary or change between one or more different type of bait 90.

Although the passage 30 is illustrated as having a substantially uniform cross section, it will be appreciated that the passage 30 may be formed in any other manner and with any other suitable shape including other cross sections and non-straight paths. The passage 30 may also include obstructions or other visual obstructions selected to reduce the observability of the impactor 54 by an animal entering the passage 30. Additionally, the passage 30 may be formed with entrances 32 from one or both sides of the impacting member 54 with the scanners 60 and sensors 120 located accordingly.

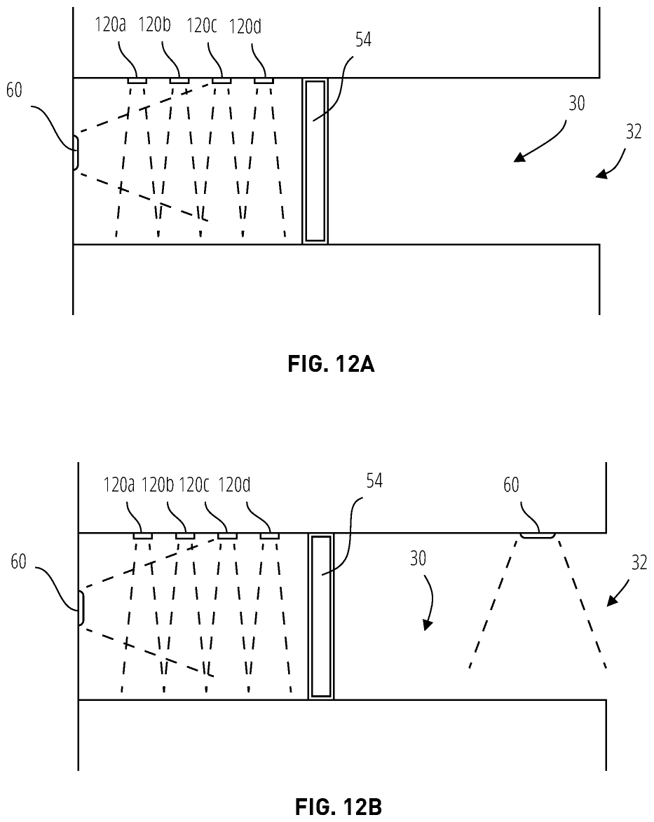

FIG. 12A and FIG. 12B further examples of the passage 30 including a plurality of sensors 120 located at a plurality of locations along the passage 30 (as indicated at 120a, 120b, 120c and 120d). Each of the sensor locations 120a-120d may correspond to a distance from the impactor 54 corresponding to a size of the animal pest. Furthermore, as illustrated, the sensors 120a-120d may be located on an opposite side of the impactor 54 from the scanner 60 such that the scanner 60 identifies the animal entering the passage 30 and the sensors 120a-120d are utilized to measure the distance of a portion of the animal pest to the impactor 54 as selected by the processor 102. In some embodiments, such as illustrated in FIG. 12A, a scanner 60 may be provided on a wall opposite the entrance 32.

While specific embodiments have been described and illustrated, such embodiments should be considered illustrative only and not as limiting the disclosure as construed in accordance with the accompanying claims.

What is claimed is:

1. An apparatus for controlling animal pests comprising:
a housing having a passage extending into the housing from an entrance;
an impacting member movable across the passage; and
at least one scanner positioned to scan the animal pest;
a processor, operably coupled to the at least one scanner and the impacting member, the processor configured to receive scanning information from the at least one scanner and adjust at least one operating parameter of the impacting member based on the scanning information,
wherein the impacting member is operable to be released to rapidly move across the passage.

2. The apparatus of claim 1, wherein the processor is further configured to identify at least one characteristic of the animal pest within the passage based on said scanning information, and wherein said adjusting is based on the at least one characteristic.

3. The apparatus of claim 2 wherein the at least one characteristic comprises an identification of the species of the animal pest.

4. The apparatus of claim 2 wherein the at least one characteristic is selected from the group consisting of: size, age, gender, body profile and weight of the animal pest.

5. The apparatus of claim 1 wherein the scanner is selected from the group consisting of: an optical camera, an infrared camera, an array of depth sensors, a LiDAR or lasers.

6. The apparatus of claim 5 wherein the scanning information provided from the at least one scanner to the processor comprises a representation of the animal pest.

7. The apparatus of claim 6 wherein the processor is configured to locate based on said profile or representation an anatomical point of the pest animal to be impacted.

8. The apparatus of claim 6 wherein the adjusting at least one operating parameter of the impacting member comprises adjusting the trigger timing of when the impacting member is caused to move across the passage.

9. The apparatus of claim 3 wherein adjusting at least one operating parameter of the impacting member comprises determining whether the impacting member is permitted to move or not depending on the identification of the animal pest.

10. The apparatus of claim 1 further comprising at least one sensor operably coupled to the processor and located within the passage, the at least one sensor configured to provide a location of the animal pest within the passage.

11. The apparatus of claim 10 wherein the at least one sensor is selected from the group consisting of an infrared sensor, a laser sensor, a light beam sensor, a motion sensor, a proximity sensor, a time-of-flight sensor, an ultrasonic sensor, a microwave sensor, a laser, an optical sensor, and a mechanical switch.

12. The apparatus of claim 10 wherein the at least one sensor is an array of sensors, each sensor in the array of sensors located at a different sensor location within the passage; and
wherein adjusting at least one operating parameter includes selecting which sensor in the array of sensors is utilized by the processor to trigger movement of the impacting member.

13. A method for controlling animal pests comprising:
providing a housing having a passage extending thereinto from an entrance;
locating an impacting member movable across the passage;
scanning with at least one scanner an animal pest entering the passage;
receiving, at a processor operably coupled to the at least one scanner and the impacting member, scanning information from the at least one scanner; and
adjusting, with the processor, at least one operating parameter of the impacting member based on the scanning information.

14. The method of claim 13, further comprising:
triggering, by the processor, the release of the impacting member based on said at least one operating parameter.

15. The method of claim 13, further comprising the step of, before said adjusting but after said receiving:
identifying at least one characteristic of the animal pest within the passage based on said scanning information; and
wherein said adjusting is based on the at least one characteristic.

16. The method of claim 15, wherein the at least one characteristic comprises an identification of the species of animal pest.

17. The method of claim 13, wherein adjusting at least one operating parameter of the impacting member comprises adjusting the trigger timing of when the impacting member is caused to move across the passage.

18. The method of claim 13, wherein adjusting at least one operating parameter of the impacting member comprises determining whether the impacting member is permitted to move or not depending on the identification of the animal pest.

19. The method of claim 13, wherein adjusting at least one operating includes selecting which sensor in an array of sensors located within the passage is utilized by the processor to trigger movement of the impacting member.

20. A non-transitory computer-readable medium storing instructions that, when executed by a processor, causes the processor to:
receive scanning information from at least one scanner operably coupled to the processor and configured to scan an animal pest entering a passage extending into a housing from an entrance; and
adjust at least one operating parameter of an impacting member coupled to the processor based on said scanning information.
